(19) United States
(12) Patent Application Publication
(10) Pub. No.: US 2023/0257102 A1
(43) Pub. Date: Aug. 17, 2023

(54) LOCKING STRUCTURE, ARM ASSEMBLY AND MOVABLE PLATFORM

(71) Applicant: SZ DJI TECHNOLOGY CO., LTD., Shenzhen (CN)

(72) Inventors: Wanren ZHOU, Shenzhen (CN); Le ZHOU, Shenzhen (CN); Chuoying LU, Shenzhen (CN); Zhan SHU, Shenzhen (CN)

(73) Assignee: SZ DJI TECHNOLOGY CO., LTD., Shenzhen (CN)

(21) Appl. No.: 18/134,463

(22) Filed: Apr. 13, 2023

Related U.S. Application Data
(63) Continuation of application No. PCT/CN2020/121983, filed on Oct. 19, 2020.

(51) Int. Cl. B64C 3/56; B64C 1/30

(52) U.S. Cl. CPC B64C 3/56; B64C 1/30

(57) ABSTRACT

The present disclosure provides a locking structure, an arm assembly and a movable platform. The locking structure includes a mounting member, a movable part member and a locking assembly. The movable part member is rotatably connected to the mounting member. The locking assembly is disposed on the mounting member or the movable member. When the mounting member and the movable member are rotated to form a preset angle, the locking assembly may synchronously lock the mounting member and the movable member in the current position, so that the movable member is kept in an unfolded state.

### RELATED APPLICATIONS

This application is a continuation application of PCT application No. PCT/CN2020/121983, filed on Oct. 19, 2020, and the content of which is incorporated herein by reference in its entirety.

### TECHNICAL FIELD

The present disclosure relates to the field of movable platform technologies, and in particular, to a locking structure, an arm assembly, and a movable platform.

### BACKGROUND

To reduce space occupied by unmanned aerial vehicles and improve storage and transportation convenience as well as economy of unmanned aerial vehicles, a common solution in the industry is to use a foldable arm. The arms of an unmanned aerial vehicle are folded when the unmanned aerial vehicle is not in use and unfolded when the unmanned aerial vehicle is needed for flight. To ensure flight stability of unmanned aerial vehicles, an arm of an existing unmanned aerial vehicle usually needs to be manually operated after the arm is unfolded, to effectively lock and fix the arm. Such a manner may easily cause a problem of crash of the unmanned aerial vehicle when an operator forgets to securely lock the arm.

### BRIEF SUMMARY

Based on this, the present disclosure provides a locking structure, an arm assembly, and a movable platform.

According to a first aspect of the present disclosure, a locking structure for a movable platform is provided, including: a mounting member; a movable member, rotatably connected to the mounting member, so that the movable member being switchable between an unfolded state and a folded state; and a locking assembly, disposed on the mounting member or the movable member, where when the mounting member and the movable member rotate to form a preset angle, the locking assembly is capable of locking the mounting member and the movable member synchronously in a current position, so that the movable member is kept in the unfolded state.

According to a second aspect of the present disclosure, an arm assembly is provided, including a locking structure including: a mounting member, a movable member, rotatably connected to the mounting member, so that the movable member being switchable between an unfolded state and a folded state; and a locking assembly, disposed on the mounting member or the movable member, and a locking assembly, disposed on the mounting member or the movable member, where when the mounting member and the movable member rotate to form a preset angle, the locking assembly is capable of locking the mounting member and the movable member synchronously in a current position, so that the movable member is kept in the unfolded state, one of the mounting member and the movable member is a connection member fixed on a center frame of a movable platform, and the other of the mounting member and the movable member is an arm configured to allow a power kit to be disposed; and a power kit, disposed on the arm.

According to a third aspect of the present disclosure, a movable platform is provided, including: a locking structure including: a mounting member, a movable member, rotatably connected to the mounting member, so that the movable member being switchable between an unfolded state and a folded state; and a locking assembly, disposed on the mounting member or the movable member, and a locking assembly, disposed on the mounting member or the movable member, where when the mounting member and the movable member rotate to form a preset angle, the locking assembly is capable of locking the mounting member and the movable member synchronously in a current position, so that the movable member is kept in the unfolded state, one of the mounting member and the movable member is a connection member fixed on a center frame of a movable platform, and the other of the mounting member and the movable member is an arm configured to allow a power kit to be disposed; and a power kit, disposed on the arm.

Some exemplary embodiments of the present disclosure provide a locking structure, an arm assembly, and a movable platform. During a process in which a movable member and a mounting member rotate relative to each other to unfold the movable member, when the movable member switches from a folded state to an unfolded state, a locking assembly can automatically lock the mounting member and the movable member synchronously, so that the movable member can be reliably kept in the unfolded state, and the mounting member and the movable member can be locked, without an additional manual operation on the locking assembly, in a current position corresponding to the unfolded state. Therefore, the operation is simple and convenient, and a problem of potential safety hazards caused when an operator forgets to securely lock the movable member may be avoided.

### BRIEF DESCRIPTION OF THE DRAWINGS

To describe the technical solutions in some exemplary embodiments of the present disclosure, the accompanying drawings required to describe the exemplary embodiments will be briefly described below. Apparently, the accompanying drawings described below are only some exemplary embodiments of the present disclosure. A person of ordinary skill in the art may further obtain other drawings based on these accompanying drawings without creative efforts.

FIG. 1 is a schematic structural diagram, from an angle of view, of a locking structure according to some exemplary embodiments of the present disclosure, where a movable member is in a folded state;

FIG. 2 is a schematic structural diagram, from another angle of view, of a locking structure according to some exemplary embodiments of the present disclosure, where a movable member is in a folded state;

FIG. 3 is a schematic diagram of a cross section of the locking structure along A-A in FIG. 2;

FIG. 4 is a schematic structural diagram, from an angle of view, of a locking structure according to some exemplary embodiments of the present disclosure, where a movable member is in an unfolded state;

FIG. 5 is a schematic structural diagram, from another angle of view, of a locking structure according to some exemplary embodiments of the present disclosure, where a movable member is in an unfolded state;

FIG. 6 is a schematic diagram of a cross section of the locking structure along B-B in FIG. 5;

FIG. 7 is a schematic exploded diagram of a locking structure according to some exemplary embodiments of the present disclosure;

FIG. 8 is a schematic structural diagram, from an angle of view, of a locking structure according to some exemplary embodiments of the present disclosure, where a movable member is in an unfolded state;

FIG. 9 is a schematic structural diagram, from another angle of view, of a locking structure according to some exemplary embodiments of the present disclosure, where a movable member is in an unfolded state;

FIG. 10 is a schematic diagram of a cross section of the locking structure along C-C in FIG. 9;

FIG. 11 is a schematic exploded diagram of the locking structure in FIG. 9;

FIG. 12 is a partially enlarged view of FIG. 6 at E;

FIG. 13 is a schematic structural diagram of a mounting member according to some exemplary embodiments of the present disclosure;

FIG. 14 is a schematic structural diagram of a movable member according to some exemplary embodiments of the present disclosure;

FIG. 15 is a schematic structural diagram, from an angle of view, of a first locking member according to some exemplary embodiments of the present disclosure;

FIG. 16 is a schematic structural diagram, from another angle of view, of a first locking member according to some exemplary embodiments of the present disclosure;

FIG. 17 is a schematic structural diagram of an operating member according to some exemplary embodiments of the present disclosure;

FIG. 18 is a partially enlarged view of FIG. 3 at F;

FIG. 19 is a schematic structural diagram of a movable platform according to some exemplary embodiments of the present disclosure;

FIG. 20 is a partially enlarged view of a movable platform at G in FIG. 19; and

FIG. 21 is a partially enlarged view of a movable platform at H in FIG. 19.

### REFERENCE NUMERALS

1000. movable platform;

100. locking structure;

10. mounting member; 11. mounting body; 12. first mounting portion; 121. sub-protrusion portion; 122. first sub-mounting portion; 123. stepped surface; 124. connection surface; 125. first through hole; 126. second through hole; 13. connection rib; 14. accommodation space;

20. movable member; 21. connection body; 22. second mounting portion; 23. stop portion;

30. locking assembly; 31. operating member; 311. pressing segment; 3111. third step; 312. first connection segment; 313. second connection segment; 314. first step; 315. fourth step;

32. guide member; 321. guide hole; 3211. first sub-guide hole; 3212. second sub-guide hole; 33. limiting member;

34. first locking member; 341. first penetration hole; 3411. first sub-hole; 3412. second sub-hole; 3413. fifth step; 342. locking body; 343. first locking surface; 344. second locking surface;

35. elastic member; 36. second locking member;

40. limiting slot; 41. slot opening; 42. clamping slot; 421. first slot wall; 422. second slot wall; 43. first limiting slot; 44. second limiting slot; 50. rotating shaft; 60. first positioning slot; and

200. power kit; 300. arm assembly; 301. arm; and 400. center frame.

### DETAILED DESCRIPTION

The technical solutions in some exemplary embodiments of the present disclosure will be described below with reference to the accompanying drawings in the exemplary embodiments of the present disclosure. Apparently, the described embodiments are merely some rather than all of the embodiments of the present disclosure. All other embodiments obtained by a person of ordinary skill in the art based on the exemplary embodiments of the present disclosure without creative efforts shall fall within the scope of protection of the present disclosure.

It should also be understood that the terms used in the present disclosure are for the purpose of describing specific embodiments only and are not intended to limit the present disclosure. As used in the present disclosure and the appended claims, the singular forms “a”, “an” and “the” are intended to include the plural forms unless the context clearly indicates otherwise.

It should also be further understood that the term “and/or” as used in the present disclosure and the appended claims refers to one of or any or all possible combinations of associated items that are listed, and includes these combinations.

Some exemplary embodiments of the present disclosure will be described in detail below with reference to the accompanying drawings. If no conflict occurs, the following embodiments and features of the embodiments may be combined with each other.

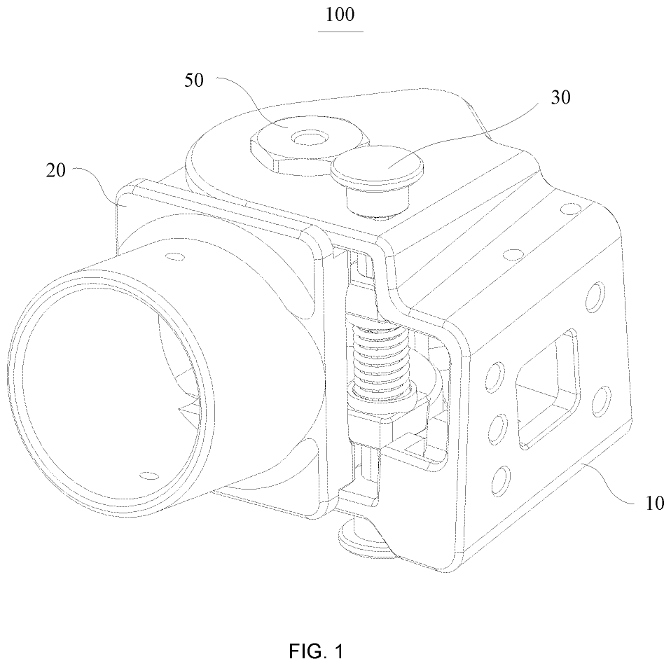

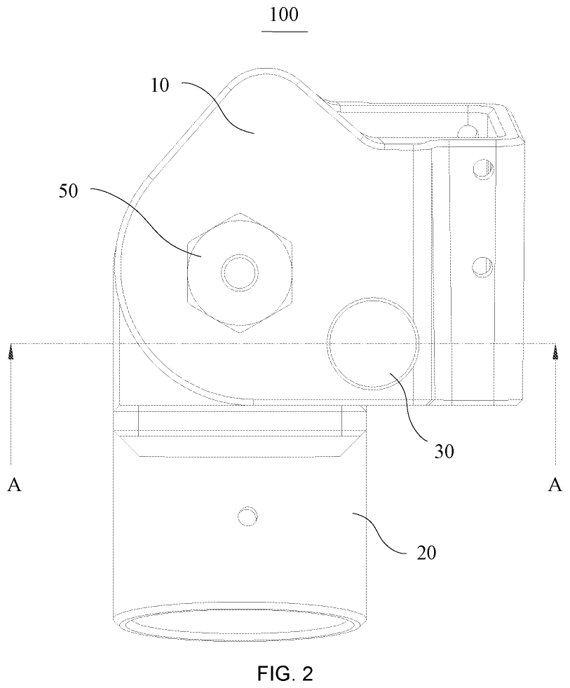

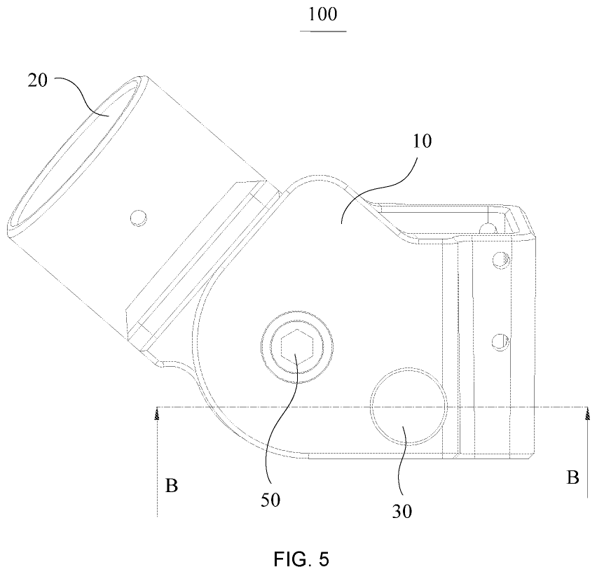

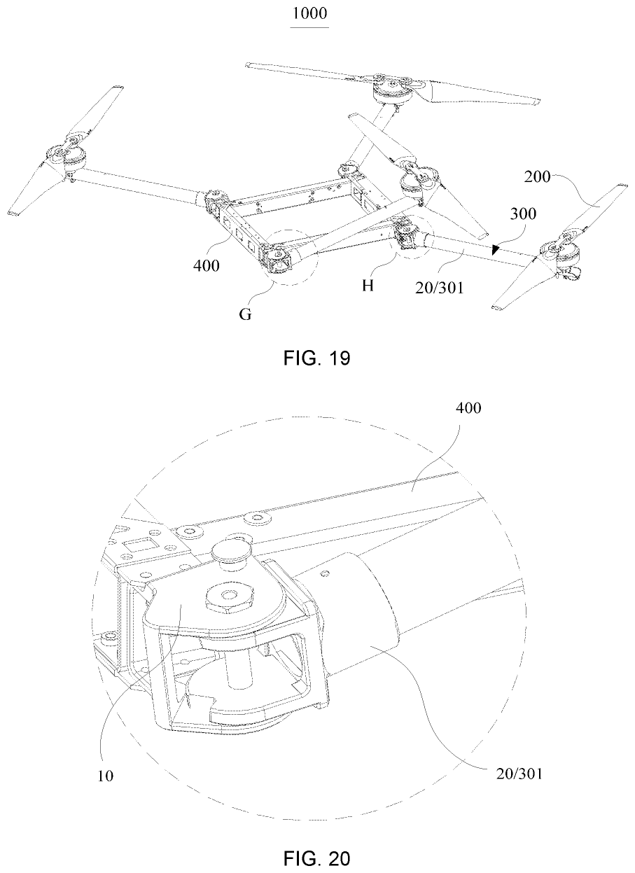

Referring to FIG. 1 to FIG. 11, some exemplary embodiments of the present disclosure provides a locking structure 100. The locking structure 100 may be applied to a movable platform 1000 (as shown in FIG. 19). The movable platform 1000 may be any object that is movable or automatically movable under an external force. For example, the movable platform 1000 may include a handheld gimbal or an unmanned aerial vehicle (UAV). Certainly, the movable platform 1000 may alternatively be an unmanned vehicle, an unmanned ship, a robot, or the like.

Referring to FIG. 1 to FIG. 11, in some exemplary embodiments, the locking structure 100 may include a mounting member 10, a movable member 20, and a locking assembly 30. The movable member 20 may be rotatably connected to the mounting member 10, so that the movable member 20 may be switchable between an unfolded state and a folded state. The locking assembly 30 may be disposed on one of the mounting member 10 and the movable member 20. When the mounting member 10 and the movable member 20 rotate to form a preset angle, the locking assembly 30 may lock the mounting member 10 and the movable member 20 synchronously in a current position, so that the movable member 20 is kept in the unfolded state.

It can be understood that, since the movable member 20 is rotatably connected to the mounting member 10, the movable member 20 and the mounting member 10 are rotatable relative to each other, and may rotate to form a proper angle at which the movable member 20 and the mounting member 10 are close to each other or away from each other, thereby implementing unfolding and folding of the movable member 20 and applications to different scenarios.

Exemplarily, when the movable member 20 is in the folded state, the locking structure 100 may be as shown in FIG. 1 to FIG. 3.

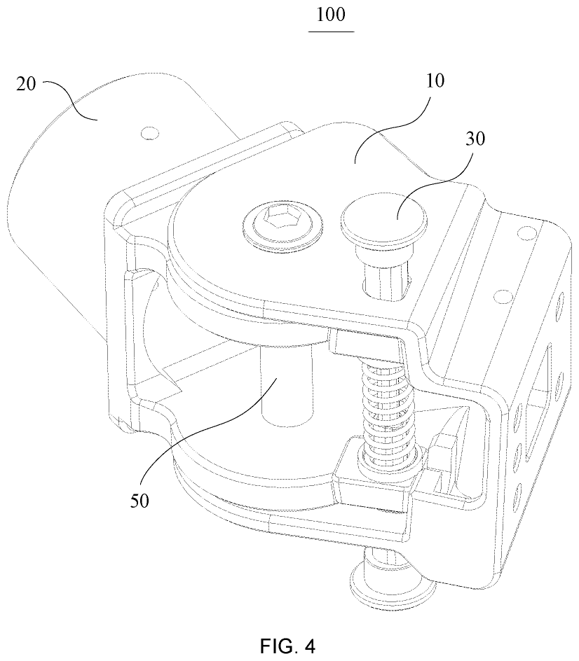

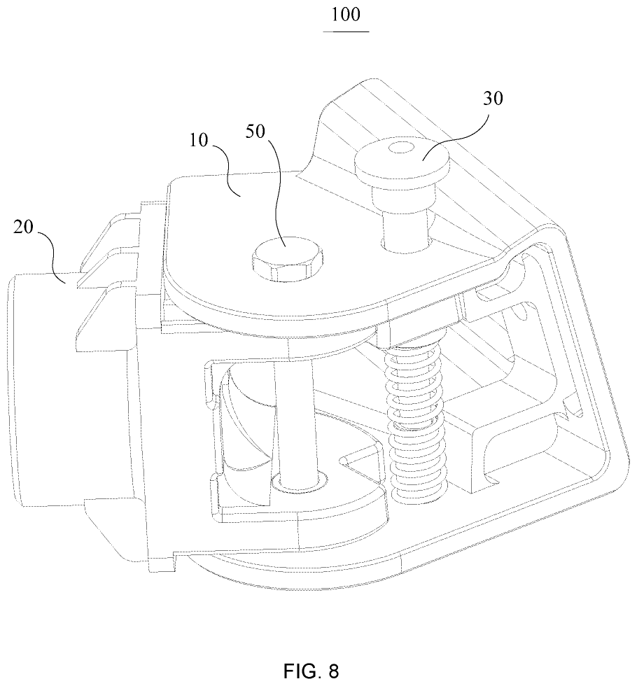

Exemplarily, when the movable member 20 is in the unfolded state, the locking structure 100 may be as shown in FIG. 4 to FIG. 6, or may be as shown in FIG. 8 to FIG. 10.

Exemplarily, when the movable platform 1000 is a UAV, one of the mounting member 10 and the movable member 20 may be a connection member configured to be connected to a center frame (as shown in FIG. 19) of the movable platform 1000, and the other of the mounting member 10 and the movable member 20 may be an arm 301 (as shown in FIG. 19) configured to allow a power kit 200 to be disposed. When the UAV flies or operates, the movable member 20 and the mounting member 10 may rotate to enable the arm 301 to switch from the folded state to the unfolded state, so that the power kit 200 is away from a body structural member of the UAV, such as the center frame, thereby avoiding mutual interference between the power kit 200 and the body structural member. However, when the UAV is not in use, the movable member 20 and the mounting member 10 may be rotate relative to each other until the arm 301 is in the folded state, thereby reducing an overall size and occupied space of the UAV, and facilitating transportation or storage of the UAV.

Certainly, the mounting member 10 and the movable member 20 may alternatively be two members in another structural body. The structural body may be any object that has an unfolded state and a folded state, for example, a handheld gimbal. Exemplarily, when the movable platform 1000 is a handheld gimbal, one of the mounting member 10 and the movable member 20 may be a first part of the handheld gimbal, and the other of the mounting member 10 and the movable member 20 may be a second part of the handheld gimbal. When the handheld gimbal is in use, the first part and the second part may rotate to enable the movable member 20 to switch from the folded state to the unfolded state. In this case, the handheld gimbal may carry an imaging device, and may adjust an imaging attitude of the imaging device and keep the imaging device in a required imaging attitude, thereby providing a stable imaging condition for the imaging device. When the handheld gimbal is not in use, the first part and the second part may be rotate relative to each other until the movable member 20 is in the folded state, thereby reducing an overall size and occupied space of the handheld gimbal, and facilitating transportation or storage of the handheld gimbal. Exemplarily, the mounting member 10 may be a motor of the handheld gimbal, and the movable member 20 may be a connection arm of the handheld gimbal. For example, the mounting member 10 may be a motor, connected to a handle, in the handheld gimbal.

In some exemplary embodiments, the preset angle formed between the movable member 20 and the mounting member 10 may generally be an angle at which the movable platform 1000 may operate. The preset angle may ensure that the power kit 200, a carried portion, or another functional component disposed on the movable member 20 is in a normal operating position. Exemplarily, the preset angle may be any proper angle between 15° to 180°, for example, 15°, 90°, 120°, 135°, 150°, 180°, or any other proper angle between 15° and 180°.

Exemplarily, the preset angle may be an angle, formed when the movable member 20 is in the unfolded state, between the mounting member 10 and the movable member 20.

Exemplarily, the current position may be a relative position between the mounting member 10 and the movable member 20 when the movable member 20 is in the unfolded state.

According to the locking structure 100 in some exemplary embodiments, during a process in which a movable member 20 and a mounting member 10 rotate relative to each other to unfold the movable member 20, when the movable member 20 switches from a folded state to an unfolded state, a locking assembly 30 may automatically lock the mounting member 10 and the movable member 20 synchronously, so that the movable member 20 may be reliably kept in the unfolded state, and the mounting member 10 and the movable member 20 may be locked, without an additional manual operation on the locking assembly 30, in a current position corresponding to the unfolded state. Therefore, the operation is simple and convenient, and a problem of potential safety hazards caused when an operator forgets to securely lock the movable member 20 is avoided.

It can be understood that, each of the unfolded state and the folded state may include one or at least two states. In other words, the unfolded state of the movable member 20 may include only one unfolded state, or may include two or more unfolded states. The folded state of the movable member 20 may include only one folded state, or may include two or more folded states.

The following uses an example in which the movable platform 1000 is a UAV for explanation and description.

When the UAV is in a flight state or another operating state, the movable member 20 and the mounting member 10 generally need to be kept constantly at a current angle, to guarantee stability of the UAV during flight. Thus, when the arm 301 is unfolded or after the arm 301 is unfolded, the arm 301 may need to be effectively locked securely and fixed, so that the movable member 20 and the mounting member 10 are kept at the current angle, that is, the movable member 20 is reliably kept in the unfolded state.

One locking manner may be as follows: After an operator manually operates the arm 301 to enable the arm 301 to rotate relative to the mounting member 10 until the arm 301 is in the unfolded state, the operator manually operates a locking structure such as a threaded sleeve or a buckle to securely lock and fix the unfolded arm 301. In such a locking manner, the operation is complicated, and since it is necessary to manually operate the locking structure to securely lock and fix the arm 301, a problem of crash of a UAV is easily caused when an operator forgets to securely lock the arm 301.

A locking manner in some exemplary embodiments of the present disclosure may be as follows: When the mounting member 10 and the arm 301 rotate to form a preset angle corresponding to the unfolded state, the locking assembly 30 may lock the mounting member 10 and the arm 301 synchronously in the current position corresponding to the unfolded state, so that the arm 301 is reliably kept in the unfolded state. According to the locking structure 100 in some exemplary embodiments of the present disclosure, a mounting member 10 and an arm 301 may be automatically locked, without an additional manual operation on the locking assembly 30, in a current position corresponding to an unfolded state. Therefore, the operation is simple and convenient, and a problem of crash of the UAV caused when an operator forgets to securely lock the arm 301 is avoided, thereby improving safety of the UAV.

In some exemplary embodiments, the locking assembly 30 may unlock the mounting member 10 and the movable member 20 under an external force, so that the movable member 20 and the mounting member 10 may rotate relative to each other. Exemplarily, an example in which the movable member 20 is the arm 301 is used for description. When the UAV does not operate, the locking assembly 30 may be operated to unlock the mounting member 10 and the arm 301. After the mounting member 10 and the arm 301 are unlocked, the arm 301 may rotate relative to the mounting member 10, and the arm 301 may switch from the unfolded state to the folded state, thereby reducing an overall size and occupied space of the UAV, and facilitating transportation or storage of the UAV.

It can be understood that, the locking assembly 30 may be manually or automatically operated, to unlock the mounting member 10 and the movable member 20. For example, the locking assembly 30 may be operated via an automation device.

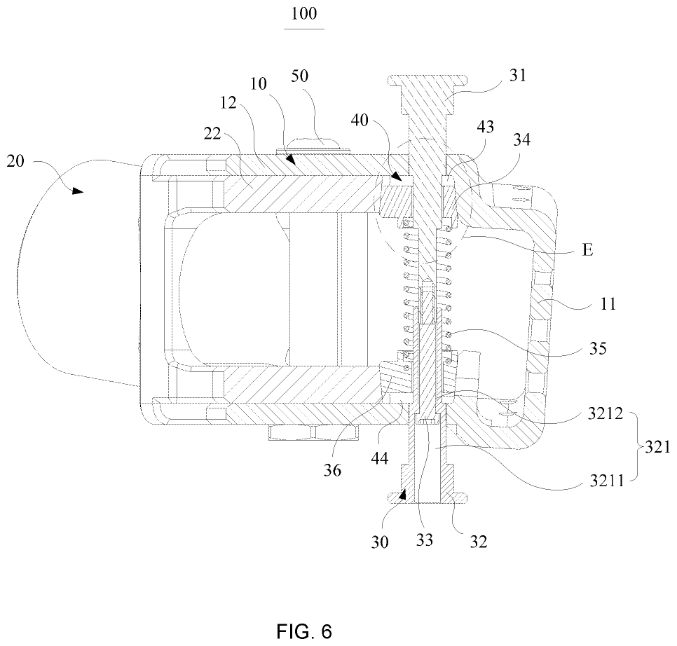

Referring to FIG. 6 and FIG. 8, in some exemplary embodiments, when the mounting member 10 and the movable member 20 rotate to form a preset angle, the mounting member 10 and the movable member 20 may cooperate to form a limiting slot 40, and part of the locking assembly 30 may be accommodated in the limiting slot 40, so as to lock the mounting member 10 and the movable member 20.

Exemplarily, when the mounting member 10 and the movable member 20 rotate until the movable member 20 is in the unfolded state, part of the locking assembly 30 may synchronously enter the limiting slot 40. In this case, the locking assembly 30 located in the limiting slot 40 is clamped between the mounting member 10 and the movable member 20, so that the mounting member 10 and the movable member 20 are locked synchronously in the current position corresponding to the unfolded state, thereby limiting relative rotation between the mounting member 10 and the movable member 20, and further reliably keeping the movable member 20 in the unfolded state.

In some exemplary embodiments, the locking assembly 30 may be disposed on the mounting member 10. In some exemplary embodiments, the locking assembly 30 may alternatively be disposed on the movable member 20, which is not limited herein.

It can be understood that, a quantity of limiting slots 40 may be designed according to actual requirements, for example, there may be one, two, three or more limiting slots 40. In some exemplary embodiments, referring to FIG. 6, there may be two limiting slots 40. Exemplarily, the two limiting slots 40 may be disposed at an interval along an axial direction of the locking assembly 30.

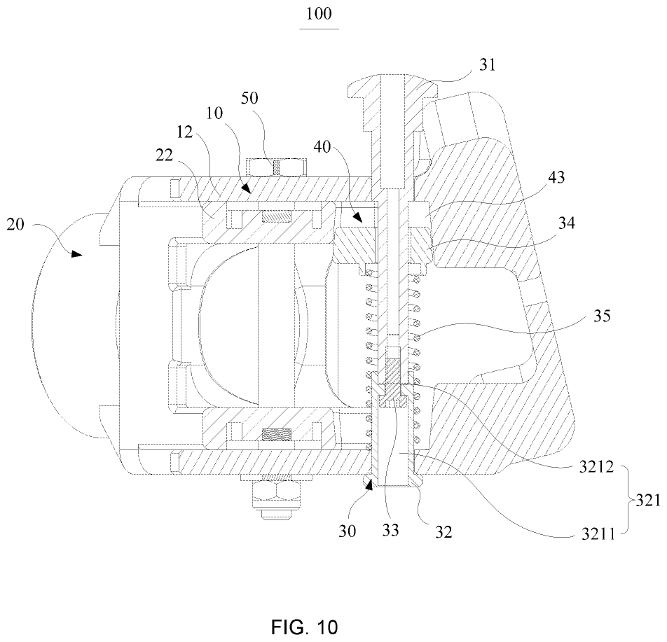

In some exemplary embodiments, referring to FIG. 10, there may be one limiting slot 40.

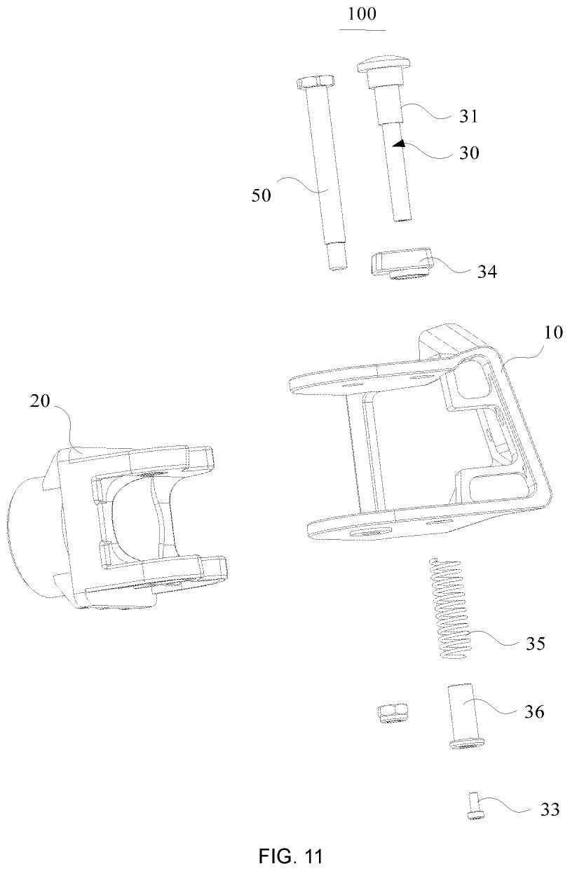

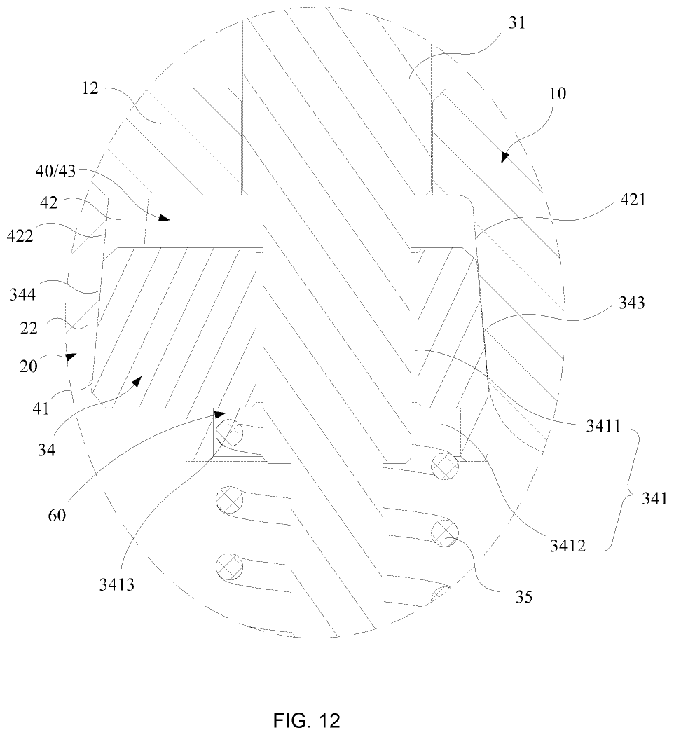

Referring to FIG. 6 and FIG. 12, in some exemplary embodiments, the limiting slot 40 may include a slot opening 41 and a clamping slot 42 communicating with the slot opening 41. Part of the locking assembly 30 may enter the clamping slot 42 through the slot opening 41 to enable the locking assembly 30 to be clamped in the clamping slot 42.

In some exemplary embodiments, the locking assembly 30 may be disengaged from the limiting slot 40 under an external force, to unlock the mounting member 10 and the movable member 20. Specifically, the locking assembly 30 located in the limiting slot 40 may be disengaged from the clamping slot 42 through the slot opening 41, to unlock the mounting member 10 and the movable member 20.

It can be understood that, when the movable member 20 needs to be unfolded, one or more of the mounting member 10 and the movable member 20 may be operated to enable the mounting member 10 and the movable member 20 to rotate relative to each other, to gradually unfold the movable member 20. When the movable member 20 switches from the folded state to the unfolded state, the slot opening 41 may synchronously allow part of the locking assembly 30 to enter the clamping slot 42. In this case, the part of the locking assembly 30 cooperates with the clamping slot 42 in a clamped manner, so that the movable member 20 is synchronously locked in the current position corresponding to the unfolded state.

When the movable member 20 needs to be folded, the locking assembly 30 may be operated to enable the locking assembly 30 located in the clamping slot 42 to be disengaged from the clamping slot 42 through the slot opening 41. When the locking assembly 30 in the clamping slot 42 is fully disengaged from the clamping slot 42, the mounting member 10 and the movable member 20 are unlocked. In this case, one or more of the mounting member 10 and the movable member 20 may be operated to enable the mounting member 10 and the movable member 20 to rotate relative to each other, so that the movable member 20 switches from the unfolded state to the folded state.

Referring to FIG. 12, with reference to FIG. 6, in some exemplary embodiments, the clamping slot 42 may include a first slot wall 421 and a second slot wall 422 that are oppositely disposed. The first slot wall 421 may be disposed on the mounting member 10, and the second slot wall 422 may be disposed on the movable member 20. Both the first slot wall 421 and the second slot wall 422 may be contactable with part of the locking assembly 30, so as to lock the mounting member 10 and the movable member 20.

Exemplarily, the first slot wall 421 may be in surface contact, point contact, or line contact with the locking assembly 30. Similarly, the second slot wall 422 may be in surface contact, point contact, or line contact with the locking assembly 30, as long as the mounting member 10 and the movable member 20 can be locked synchronously through the locking assembly 30 when the movable member 20 is unfolded to the current position corresponding to the unfolded state.

To improve locking stability of the locking assembly 30, the first slot wall 421 may be in surface contact with the locking assembly 30, and the second slot wall 422 may be in surface contact with the locking assembly 30, so that the movable member 20 can be further reliably kept in the unfolded state.

The clamping slot 42 may be designed in any suitable shape according to actual requirements, for example, a square shape, a V shape, or a right-angled trapezoidal shape.

Referring to FIG. 12 in combination with FIG. 6, in some exemplary embodiments, a slot width of the clamping slot 42 may gradually decrease along an extension direction from one end, close to the slot opening 41, of the clamping slot 42 to another end, away from the slot opening 41, of the clamping slot 42. Exemplarily, a distance between the first slot wall 421 and the second slot wall 422 may gradually decrease along an extension direction from one end, close to the slot opening 41, of each of the first slot wall 421 and the second slot wall 422 to another end, away from the slot opening 41, of each of the first slot wall 421 and the second slot wall 422, to prevent vacancy from being generated between the locking assembly 30 and the first slot wall 421, and/or to prevent vacancy from being generated between the locking assembly 30 and the second slot wall 422, thereby ensuring that the movable member 20 can be reliably kept in the unfolded state.

Referring to FIG. 12 in combination with FIG. 6, in some exemplary embodiments, a distance between one end, close to the slot opening 41, of the first slot wall 421 and an axis of the locking assembly 30 may be greater than a distance between another end, away from the slot opening 41, of the first slot wall 421 and the axis of the locking assembly 30.

Referring to FIG. 12 in combination with FIG. 6, in some exemplary embodiments, a distance between one end, close to the slot opening 41, of the second slot wall 422 and the axis of the locking assembly 30 may be greater than a distance between another end, away from the slot opening 41, of the second slot wall 422 and the axis of the locking assembly 30.

Referring to FIG. 12 in combination with FIG. 6, in some exemplary embodiments, a distance between the first slot wall 421 and the axis of the locking assembly 30 may gradually decrease along an extension direction from the end, close to the slot opening 41, of the first slot wall 421 to the end, away from the slot opening 41, of the first slot wall 421. A distance between the second slot wall 422 and the axis of the locking assembly 30 may gradually decrease along an extension direction from the end, close to the slot opening 41, of the second slot wall 422 to the end, away from the slot opening 41, of the second slot wall 422.

Referring to FIG. 12 in combination with FIG. 6, in some exemplary embodiments, the first slot wall 421 and the second slot wall 422 may cooperate to form a V-shaped slot. A slot width of the V-shaped slot may gradually decrease along an extension direction from one end, close to the slot opening 41, of the V-shaped slot to another end, away from the slot opening 41, of the V-shaped slot. In this way, even if there is an error between the clamping slot 42 and a part, used to cooperate with the clamping slot 42, in the locking assembly 30, the mounting member 10 and the movable member 20 may be well locked through the locking assembly 30, which avoids the locking assembly 30 from shaking in the clamping slot 42, so that the movable member 20 can be reliably kept in the unfolded state.

It can be understood that, each of the first slot wall 421 and the second slot wall 422 may be provided with features such as a groove, a notch, and texture, as long as a contour of the clamping slot 42 is basically V-shaped or in another required shape.

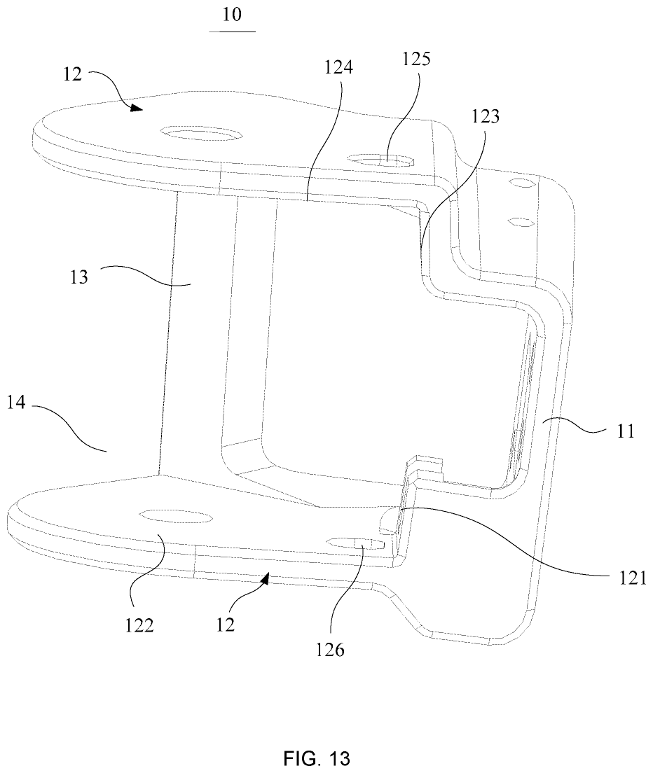

Referring to FIG. 13, with reference to FIG. 4, FIG. 6, FIG. 12, and FIG. 19, in some exemplary embodiments, the mounting member 10 may include a mounting body 11 and a first mounting portion 12. The first mounting portion 12 may be fixedly connected to the mounting body 11. The first mounting portion 12 may be rotatably connected to the movable member 20. The first mounting portion 12 may cooperate with the movable member 20 to form a limiting slot 40. Exemplarily, the mounting body 11 may be configured to be connected to a frame member of the center frame 400 in FIG. 19. The mounting body 11 and at least part of the frame member may be of an integrated structure. The mounting body 11 and at least part of the frame member may alternatively be of a split structure. For example, the mounting body 11 may be fixedly connected to the frame member through a quick disassembly piece, a thread, a buckle, or the like.

Referring to FIG. 13, in some exemplary embodiments, there may be two first mounting portions 12, and the two first mounting portions 12 may be oppositely disposed at an interval on the mounting body 11. Exemplarily, the two first mounting portions 12 may be disposed on two opposite edges of the mounting body 11, respectively.

Referring to FIG. 13, in some exemplary embodiments, a connection rib 13 may also be connected between the two first mounting portions 12 and configured to enhance strength of the mounting member 10.

Referring to FIG. 13, in some exemplary embodiments, the first mounting portion 12 may be disposed non-parallel to the mounting body 11. Exemplarily, the first mounting portion 12 may be formed by bending and extending an edge of the mounting body 11.

In some exemplary embodiments, the first mounting portion 12 and the mounting body 11 may be integrally formed, to reduce assembly steps, and improve assembly efficiency. In some exemplary embodiments, the first mounting portion 12 and the mounting body 11 may alternatively be disposed in a split manner, for example, may be connected through a quick disassembly piece or the like.

Exemplarily, the mounting body 11 may be designed to any suitable shape according to actual requirements, for example, a plate shape, a sheet shape, or another regular shape or irregular shape.

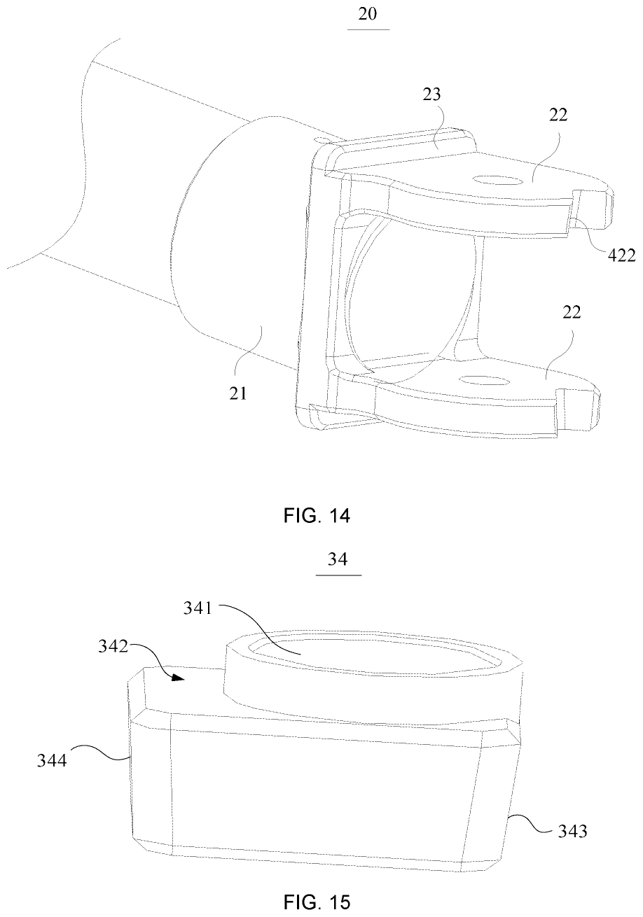

Referring to FIG. 14, with reference to FIG. 4, FIG. 6, and FIG. 12, in some exemplary embodiments, the movable member 20 may include a connection body 21 and a second mounting portion 22. The second mounting portion 22 may be fixedly connected to the connection body 21. The second mounting portion 22 may be rotatably connected to the first mounting portion 12, so that the movable member 20 and the mounting member 10 may be rotatable relative to each other. The first mounting portion 12 may cooperate with the second mounting portion 22 to form the limiting slot 40.

Referring to FIG. 14, in some exemplary embodiments, there may be two second mounting portions 22, and the two second mounting portions 22 may be oppositely disposed at an interval on the connection body 21.

Referring to FIG. 14, in some exemplary embodiments, the second mounting portion 22 may be disposed on the connection body 21 in a protruding manner.

In some exemplary embodiments, the second mounting portion 22 and at least part of the connection body 21 may be integrally formed, so as to reduce assembly steps and improve assembly efficiency. In some exemplary embodiments, the second mounting portion 22 and the connection body 21 may alternatively be disposed in a split manner, for example, may be connected through a quick disassembly piece or the like.

In some exemplary embodiments, the connection body 21 may include a first connection part and a second connection part connected to the first connection part, and the second connection part may be connected to the second mounting portion 22. In some exemplary embodiments, the first connection part and the second connection part may be integrally formed. In some exemplary embodiments, the first connection part and the second connection part may alternatively be disposed in a split manner, for example, may be connected through a quick disassembly piece, a buckle, or the like.

Exemplarily, the connection body 21 may be designed in any suitable shape according to actual requirements, for example, a rod body shape, or another regular shape or irregular shape.

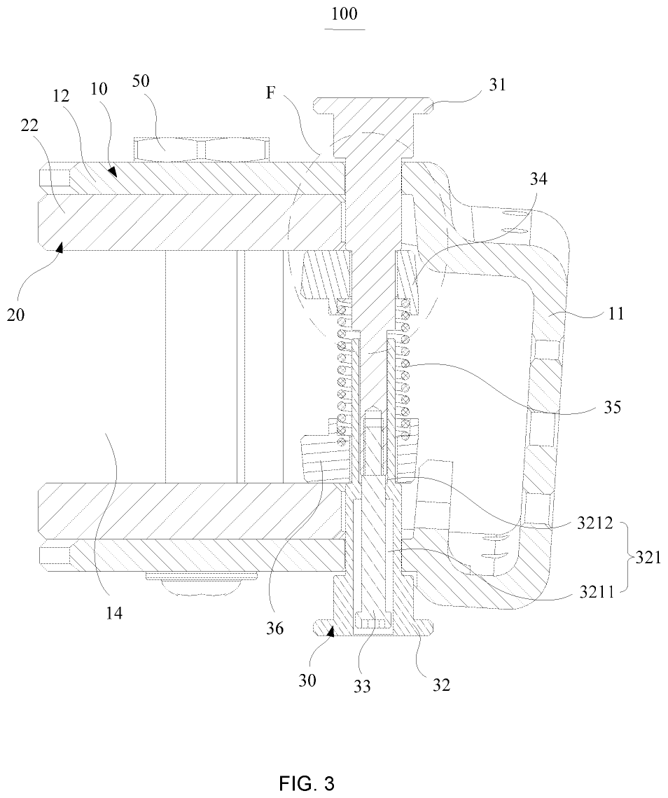

Referring to FIG. 3 and FIG. 13, in some exemplary embodiments, there may be two first mounting portions 12. The two first mounting portions 12 may be oppositely disposed at an interval to form an accommodation space 14, thereby providing a mounting space for the second mounting portion 22. At least part of the second mounting portion 22 may be accommodated in the accommodation space 14.

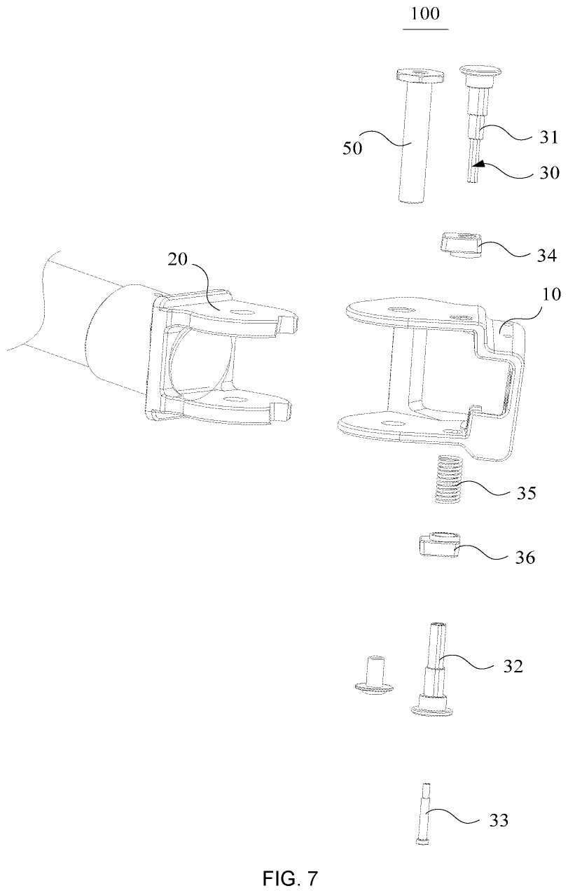

Referring to FIG. 3, FIG. 6, FIG. 7, FIG. 10, and FIG. 11, in some exemplary embodiments, the first mounting portion 12 may be rotatably connected to the second mounting portion 22 via a rotating shaft 50. Specifically, the rotating shaft 50 may penetrate through the first mounting portion 12 and the second mounting portion 22. One or more of the movable member 20 and the mounting member 10 may be rotatable around the rotating shaft 50, so that the movable member 20 is switchable between the unfolded state and the folded state.

Referring to FIG. 14 in combination with FIG. 1 and FIG. 4, in some exemplary embodiments, the movable member 20 may further include a stop portion 23 disposed on the connection body 21. The stop portion 23 may cooperate with the first mounting portion 12 to limit the rotation between the first mounting portion 12 and the second mounting portion 22. When one or more of the movable member 20 and the mounting member 10 rotate until an angle between the movable member 20 and the mounting member 10 is a target angle, the stop portion 23 may abut against the first mounting portion 12. In this case, the movable member 20 and the mounting member 10 cannot further rotate relative to each other.

The target angle may be set according to actual requirements. For example, the target angle may be an angle, corresponding to the folded state, between the movable member 20 and the mounting member 10, or may be a preset angle or the like corresponding to the unfolded state. In this way, a case in which a degree of relative rotation between the movable member 20 and the mounting member 10 is too large may be avoided, thereby ensuring that the movable member 20 can quickly switch between the unfolded state and the folded state.

Referring to FIG. 14, in some exemplary embodiments, the stop portion 23 may be disposed on the connection body 21 and/or the second mounting portion 22 in a protruding manner. In other words, the stop portion 23 may be disposed on one of the connection body 21 and the second mounting portion 22. The stop portion 23 may alternatively be disposed on both the connection body 21 and the second mounting portion 22.

The stop portion 23 may be designed to be of any suitable structure according to actual requirements, for example, a flanging structure.

Referring to FIG. 14, exemplarily, the two second mounting portions 22 may be oppositely disposed at an interval on the connection body 21. The two second mounting portions 22 may cooperate to form an interval space. The stop portion 23 may be disposed on one side, away from the interval space, of the connection body 21 and/or the second mounting portion 22.

Referring to FIG. 12 and FIG. 13, in some exemplary embodiments, a sub-protrusion portion 121 may be disposed on the first mounting portion 12. The first slot wall 421 may be disposed on the sub-protrusion portion 121. The second slot wall 422 may be disposed on the second mounting portion 22. Exemplarily, the first mounting portion 12 may include the sub-protrusion portion 121 and a first sub-mounting portion 122. The sub-protrusion portion 121 may be disposed on the first sub-mounting portion 122 in a protruding manner. The first slot wall 421 may be disposed in a manner of intersecting with the first sub-mounting portion 122. For example, an angle between the first slot wall 421 and the first sub-mounting portion 122 may be an obtuse angle. The second slot wall 422 may be disposed at one end, away from the connection body 21, of the second mounting portion 22.

Referring to FIG. 13, in some exemplary embodiments, the first mounting portion 12 may be stepped. The first slot wall 421 may be disposed on a stepped surface 123 of the first mounting portion 12. The second slot wall 422 may be disposed on the second mounting portion 22. Exemplarily, the stepped surface 123 may be connected to a connection surface 124, and the stepped surface 123 may be disposed in a manner of intersecting with the connection surface 124. For example, an angle between the stepped surface 123 and the connection surface 124 may be an obtuse angle. The second slot wall 422 may be disposed at one end, away from the connection body 21, of the second mounting portion 22.

In some exemplary embodiments, the locking assembly 30 may be a pressing-type locking assembly or a rotary-knob-type locking assembly. When the locking assembly 30 is the pressing-type locking assembly, the locking assembly 30 may be pressed to enable the locking assembly 30 located in the clamping slot 42 to be disengaged from the slot opening 41, so that the mounting member 10 and the movable member 20 are unlocked. When the locking assembly 30 is the rotary-knob-type locking assembly, the locking assembly 30 may be rotated to enable the locking assembly 30 located in the clamping slot 42 to be disengaged from the slot opening 41, so that the mounting member 10 and the movable member 20 are unlocked.

Referring to FIG. 6, FIG. 10, and FIG. 12, in some exemplary embodiments, the limiting slot 40 may include a first limiting slot 43. Referring to FIG. 1 to FIG. 12, the locking assembly 30 may include an operating member 31, a guide member 32, a limiting member 33, a first locking member 34, and an elastic member 35. The operating member 31 may be disposed on the mounting member 10. The guide member 32 may be disposed on the mounting member 10. The limiting member 33 may be connected to the guide member 32 and the operating member 31, and the limiting member 33 may be configured to limit the guide member 32 and the operating member 31.

The first locking member 34 may be sleeved over the operating member 31. When the mounting member 10 and the movable member 20 rotate to form a preset angle, at least part of the first locking member 34 may synchronously enter the first limiting slot 43, so that the mounting member 10 and the movable member 20 are locked synchronously in the current position. The elastic member 35 may be sleeved on the operating member 31 and the guide member 32. The elastic member 35 may abut against the first locking member 34. The operating member 31 may drive the first locking member 34 to be disengaged from the first limiting slot 43 under an external force.

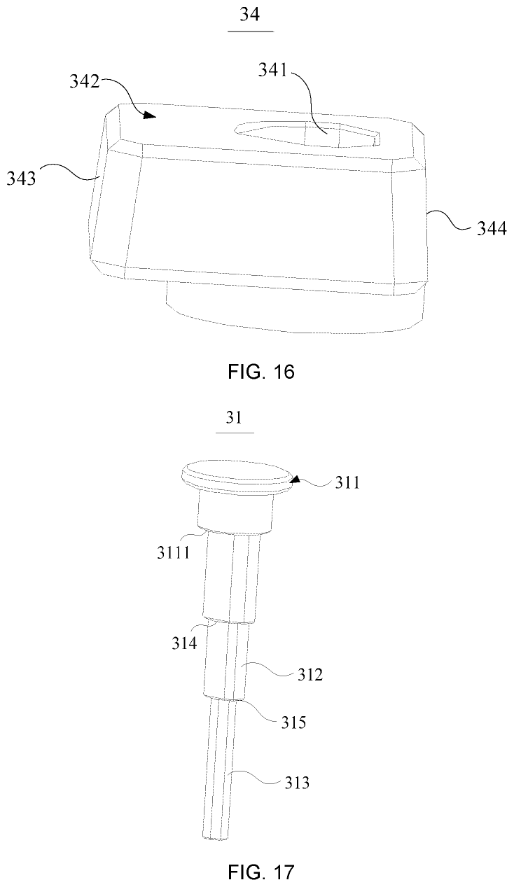

Referring to FIG. 10 and FIG. 13, in some exemplary embodiments, a first through hole 125 may be formed in one of the first mounting portions 12 of the mounting member 10, and a second through hole 126 may be formed in the other of the first mounting portions 12 of the mounting member 10. Both the first through hole 125 and the second through hole 126 may communicate with the accommodation space 14. Referring to FIG. 15 and FIG. 16, a first penetration hole 341 may be formed in the first locking member 34. The operating member 31 may penetrate through one of the first through hole 125 and the second through hole 126, and may penetrate through the first penetration hole 341 and be connected to the guide member 32 and/or the limiting member 33. The guide member 32 may penetrate through the other of the first through hole 125 and the second through hole 126. For example, the operating member 31 may penetrate through the first through hole 125 and the first penetration hole 341, and the guide member 32 may penetrate through the second through hole 126.

In some exemplary embodiments, the first through hole 125 and the second through hole 126 may be oppositely disposed. Exemplarily, an axial direction of the first through hole 125 may coincide or substantially coincide with an axial direction of the second through hole 126.

Exemplarily, an expansion direction of the elastic member 35 may be parallel or substantially parallel to the axial direction of the first through hole 125.

Referring to FIG. 17, with reference to FIG. 6 and FIG. 12, in some exemplary embodiments, the operating member 31 may include a pressing segment 311, a first connection segment 312, and a second connection segment 313. One end of the first connection segment 312 may be connected to the pressing segment 311. The first connection segment 312 may penetrate through the first locking member 34. The second connection segment 313 may be connected to another end of the first connection segment 312. The limiting member 33 may penetrate through the guide member 32 and be connected to the second connection segment 313, so that the guide member 32 and the operating member 31 are connectable. When the pressing segment 311 is pressed, the limiting member 33 may also limit the movement of the guide member 32 and/or the operating member 31 along a preset direction, so that the first locking member 34 located in the first limiting slot 43 is disengaged from the first limiting slot 43 through the slot opening 41 of the first limiting slot 43. The preset direction may be designed as any suitable direction according to actual requirements, for example, may be an axial direction of the operating member 31 or an axial direction of the guide member 32. In another example, the preset direction may be parallel to a connecting line between a center of the first through hole 125 and a center of the second through hole 126.

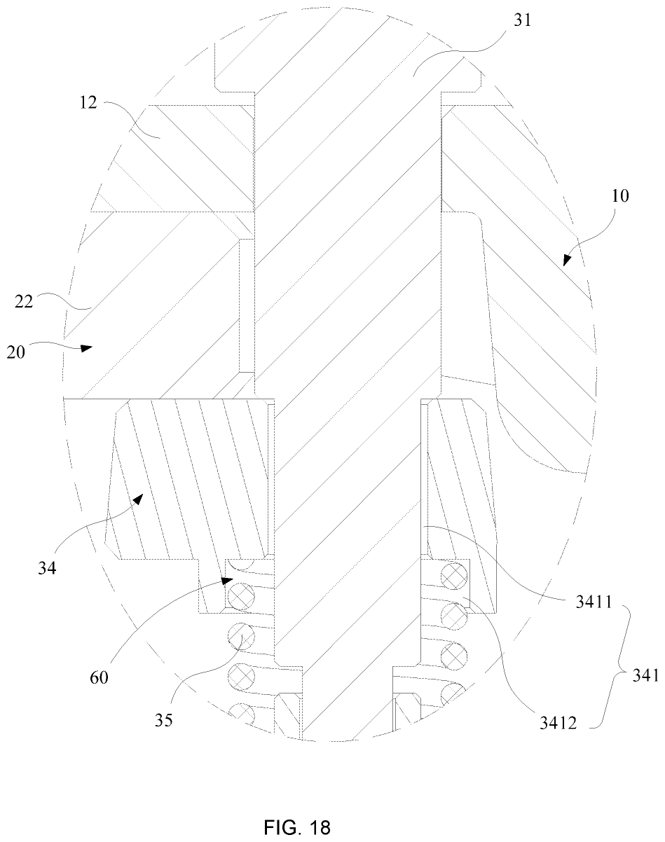

Referring to FIG. 17 and FIG. 18 in combination with FIG. 3, FIG. 6, and FIG. 12, in some exemplary embodiments, the pressing segment 311 and the first connection segment 312 may form a first step 314. The pressing segment 311 may move along a direction approaching the slot opening 41 of the first limiting slot 43 under an external force, so that the first step 314 may abut against the first locking member 34 and drive the first locking member 34 to disengage from the first limiting slot 43.

Exemplarily, a peripheral size of the pressing segment 311 may be greater than a peripheral size of the first connection segment 312, so that the first step 314 may be formed in a position where the pressing segment 311 and the first connection segment 312 are connected.

In some exemplary embodiments, the operating member 31 may be movably connected to the first mounting portion 12. The operating member 31 may be movably connected to the first locking member 34. The operating member 31 may be movably connected to the guide member 32.

In some exemplary embodiments, as shown in FIG. 3 and FIG. 18, when the movable member 20 is in the folded state, a stepped surface of the first step 314 may abut against the first locking member 34. As shown in FIG. 6 and FIG. 12, when the movable member 20 is in the unfolded state, a stepped surface of the first step 314 may be disposed in a manner of being spaced from or in contact with the first locking member 34.

Referring to FIG. 17 in combination with FIG. 3, FIG. 6, FIG. 12, and FIG. 18, exemplarily, the pressing segment 311 may further include a third step 3111, which may be configured to limit relative movement between the operating member 31 and the first mounting portion 12, so as to prevent the pressing segment 311 from fully entering the first through hole 125 of the first mounting portion 12.

In some exemplary embodiments, as shown in FIG. 3 and FIG. 18, when the movable member 20 is in the folded state, a stepped surface of the third step 3111 may be disposed in a manner of being spaced from a surface on a side, away from the accommodation space 14, of the first mounting portion 12 by a first interval distance. As shown in FIG. 6 and FIG. 12, when the movable member 20 is in the unfolded state, the stepped surface of the third step 3111 may be disposed in a manner of being spaced from the surface on a side, away from the accommodation space 14, of the first mounting portion 12 by a second interval distance. The first interval distance may be less than the second interval distance. Exemplarily, the first interval distance may be greater than or equal to zero.

Referring to FIG. 17 in combination with FIG. 3 and FIG. 6, in some exemplary embodiments, the first connection segment 312 and the second connection segment 313 may cooperate to form a fourth step 315, which may be configured to limit relative movement between the operating member 31 and the guide member 32. Exemplarily, a peripheral size of the first connection segment 312 may be greater than a peripheral size of the second connection segment 313, so that the fourth step 315 may be formed in a position where the first connection segment 312 and the second connection segment 313 are connected.

Exemplarily, as shown in FIG. 3 and FIG. 18, when the movable member 20 is in the folded state, a stepped surface of the fourth step 315 may be disposed in a manner of being spaced from an end, facing the first locking member 34, of the guide member 32 by a third interval distance. As shown in FIG. 6 and FIG. 12, when the movable member 20 is in the unfolded state, the stepped surface of the fourth step 315 may be disposed in a manner of being spaced from an end, facing the first locking member 34, of the guide member 32 by a fourth interval distance. The fourth interval distance may be greater than the third interval distance. Exemplarily, the third interval distance may be greater than or equal to zero.

In some exemplary embodiments, the pressing segment 311, the first connection segment 312, and the second connection segment 313 may be integrally formed. In some exemplary embodiments, the pressing segment 311, the first connection segment 312, and the second connection segment 313 may be disposed in a split manner and fixedly connected through a buckle, a quick disassembly piece, a thread, or the like. Certainly, in some exemplary embodiments, two of the pressing segment 311, the first connection segment 312, and the second connection segment 313 may be integrally formed, and the integrally formed structure and the other one of the pressing segment 311, the first connection segment 312, and the second connection segment 313 may be disposed in a split manner, which is not limited herein.

Referring to FIG. 6 and FIG. 12, in some exemplary embodiments, the first penetration hole 341 of the first locking member 34 may be configured to allow the first connection segment 312 to penetrate therethrough. The first penetration hole 341 may cooperate with the first connection segment 312 to form a first positioning slot 60. One end of the elastic member 35 may be located in the first positioning slot 60, to position the elastic member 35. Exemplarily, the first positioning slot 60 may be disposed on a side, facing the elastic member 35, of the first locking member 34.

Referring to FIG. 6 and FIG. 12, in some exemplary embodiments, the first penetration hole 341 may include a first sub-hole 3411 and a second sub-hole 3412 that communicate with each other. The second sub-hole 3412 may be disposed away from the pressing segment 311. The second sub-hole 3412 may cooperate with the first connection segment 312 to form the first positioning slot 60. Exemplarily, the first sub-hole 3411 and the second sub-hole 3412 may be coaxially disposed.

In some exemplary embodiments, a diameter of the second sub-hole 3412 may be greater than a diameter of the first sub-hole 3411, so that a fifth step 3413 may be formed in a position where the first sub-hole 3411 and the second sub-hole 3412 communicate with each other. One end of the elastic member 35 can abut against a stepped surface of the fifth step 3413.

In some exemplary embodiments, one end of the elastic member 35 may abut against both the stepped surface of the fourth step 315 and the stepped surface of the fifth step 3413. When the movable member 20 switches from the folded state to the unfolded state to form the first limiting slot 43, at least part of the first locking member 34 may enter the clamping slot 42 of the first limiting slot 43 through the slot opening 41 of the first limiting slot 43 by the elastic member 35.

Referring to FIG. 3, FIG. 6, and FIG. 10, in some exemplary embodiments, a guide hole 321 extending along an expansion direction of the elastic member 35 may be formed in the guide member 32. One or more of the operating member 31 and the limiting member 33 may move along an axial direction of the guide hole 321.

Exemplarily, when the movable member 20 is in the unfolded state, the stepped surface of the first step 314 may be spaced from the first locking member 34 by a preset distance. The preset distance may be greater than or equal to zero. The operating member 31 may have an operation end and a connection end that are oppositely disposed. The connection end of the operating member 31 may be connected to the limiting member 33 and/or the guide member 32.

When the operation end of the operating member 31 is pressed, the operating member 31 and the limiting member 33 may move relative to the guide member 32 along the axial direction of the guide hole 321, and the operation end of the operating member 31 may gradually move close to the guide member 32. When the operating member 31 moves relative to the guide member 32 by a preset distance, the operating member 31 may be in contact with the first locking member 34. In this case, the operating member 31 may be further pressed, so that the operating member 31 may exert a force on the first locking member 34 to enable the first locking member 34 located in the first limiting slot 43 to gradually leave the clamping slot 42 of the first limiting slot 43 through the slot opening 41 of the first limiting slot 43, and further enable the first locking member 34 to press the elastic member 35. When the first locking member 34 fully leaves the clamping slot 42 of the first limiting slot 43, the mounting member 10 and the movable member 20 may be unlocked. In this case, the movable member 20 may be operated to enable the movable member 20 to switch from the unfolded state to the folded state. During a process in which the movable member 20 switches to the folded state, when a surface on a side, away from the first mounting portion 12, of the second mounting portion 22 is in contact with a surface on a side, close to the first mounting portion 12, of the first locking member 34, the operating member 31 may be released.

When the movable member 20 needs to switch from the folded state to the unfolded state, one or more of the movable member 20 and the mounting member 10 may be operated to enable the movable member 20 and the mounting member 10 to be gradually unfolded. When the movable member 20 is unfolded relative to the mounting member 10 until the first limiting slot 43 is formed between the movable member 20 and the mounting member 10, at least part of the first locking member 34 may synchronously enter the clamping slot 42 of the first limiting slot 43 through the slot opening 41 of the first limiting slot 43 driven by the elastic member 35, so as to securely lock the mounting member 10 and the movable member 20.

Referring to FIG. 3, FIG. 6, and FIG. 10, in some exemplary embodiments, the guide hole 321 may include a first sub-guide hole 3211 and a second sub-guide hole 3212 that communicate with each other. A diameter of the first sub-guide hole 3211 may be greater than a diameter of the second sub-guide hole 3212, so as to form a second step, and a large-diameter end of the limiting member 33 may be disposed in the first sub-guide hole 3211. The large-diameter end of the limiting member 33 may cooperate with the second step, so that a total movement distance between the operating member 31 and the movable member 20 may be limited.

In some exemplary embodiments, the diameter of the first sub-guide hole 3211 may be greater than a diameter of a hole portion, configured to be connected to the first sub-guide hole 3211, of the second sub-guide hole 3212. The large-diameter end of the limiting member 33 may be disposed in the first sub-guide hole 3211.

It can be understood that, the limiting member 33 may be designed to be of any suitable structure according to actual requirements, for example, may be a limiting screw or the like.

Referring to FIG. 15 and FIG. 16 in combination with FIG. 6 and FIG. 12, in some exemplary embodiments, the first locking member 34 may include a locking body 342, a first locking surface 343, and a second locking surface 344. The second locking surface 344 and the first locking surface 343 may be oppositely disposed on the locking body 342. The first locking surface 343 is contactable with the mounting member 10, and the second locking surface 344 is contactable with the movable member 20, so as to lock the mounting member 10 and the movable member 20, and further reliably keep the movable member 20 in the unfolded state. Exemplarily, the first penetration hole 341 may penetrate through the locking body 342.

Referring to FIG. 12, in some exemplary embodiments, the first locking surface 343 and the second locking surface 344 may cooperate with the first slot wall 421 and the second slot wall 422 of the first limiting slot 43, respectively. Exemplarily, when the movable member 20 rotates relative to the mounting member 10 to a current position corresponding to the unfolded state, the first locking surface 343 may be in contact with the first slot wall 421 of the first limiting slot 43, the second locking surface 344 may be in contact with the second slot wall 422 of the first limiting slot 43, and at least part of the locking body 342 may be located in the clamping slot 42 of the first limiting slot 43, so that the mounting member 10 and the movable member 20 are locked, and the movable member 20 is reliably kept in the unfolded state.

Referring to FIG. 6 and FIG. 12, in some exemplary embodiments, the limiting slot 40 may include a second limiting slot 44. The locking assembly 30 may further include a second locking member 36. The second locking member 36 may be sleeved on the guide member 32. When the mounting member 10 and the movable member 20 rotate to form a preset angle, at least part of the second locking member 36 may synchronously enter the second limiting slot 44 to lock the mounting member 10 and the movable member 20 synchronously in the current position. Two ends of the elastic member 35 may abut against the first locking member 34 and the second locking member 36, respectively. The guide member 32 may drive, under an external force, the second locking member 36 to be disengaged from the second limiting slot 44.

Exemplarily, when the operation end of the operating member 31 is pressed, the operating member 31 and the limiting member 33 may move relative to the guide member 32 along the axial direction of the guide hole 321, and the operation end of the operating member 31 may gradually move close to the guide member 32. When the operating member 31 is in contact with the first locking member 34, if the operating member 31 is further pressed, the operating member 31 may exert a force on the first locking member 34 to enable the first locking member 34 located in the first limiting slot 43 to gradually leave the clamping slot 42 of the first limiting slot 43 through the slot opening 41 of the first limiting slot 43, and further enable the first locking member 34 to press the elastic member 35.

Similarly, when an operation end of the guide member 32 is pressed, the guide member 32 may move relative to the operating member 31 and the limiting member 33 along the axial direction of the guide hole 321, and the operation end of the guide member 32 may gradually move close to the operating member 31. When the guide member 32 is in contact with the second locking member 36, if the guide member 32 is further pressed, the guide member 32 may exert a force on the second locking member 36 to enable the second locking member 36 located in the second limiting slot 44 to gradually leave the clamping slot 42 of the second limiting slot 44 through the slot opening 41 of the second limiting slot 44, and further enable the second locking member 36 to press the elastic member 35.

When the first locking member 34 fully leaves the clamping slot 42 of the first limiting slot 43, and the second locking member 36 fully leaves the clamping slot 42 of the second limiting slot 44, the mounting member 10 and the movable member 20 may be unlocked. In this case, the movable member 20 may be operated to enable the movable member 20 to switch from the unfolded state to the folded state. During a process in which the movable member 20 switches to the folded state, when a surface on one side, away from the first mounting portion 12, of one of the second mounting portions 22 is in contact with a surface on one side, close to the first mounting portion 12, of the first locking member 34, and a surface on one side, away from the first mounting portion 12, of the other of the second mounting portions 22 is in contact with a surface on one side, close to the first mounting portion 12, of the second locking member 36, the operating member 31 may be released.

When the movable member 20 needs to switch from the folded state to the unfolded state, one or more of the movable member 20 and the mounting member 10 may be operated to enable the movable member 20 and the mounting member 10 to be gradually unfolded. When the movable member 20 is unfolded relative to the mounting member 10 until the first limiting slot 43 and the second limiting slot 44 are formed between the movable member 20 and the mounting member 10, at least part of the first locking member 34 enters, driven by the elastic member 35, the clamping slot 42 of the first limiting slot 43 through the slot opening 41 of the first limiting slot 43, and at least of part of the second locking member 36 enters, driven by the elastic member 35, the clamping slot 42 of the second limiting slot 44 through the slot opening 41 of the second limiting slot 44, so as to securely lock the mounting member 10 and the movable member 20, and prevent relative rotation between the mounting member 10 and the movable member 20.

A shape of the second limiting slot 44 may be the same as or different from a shape of the first limiting slot 43. Exemplarily, the second limiting slot 44 may be disposed symmetrically with the first limiting slot 43.

A structure of the first locking member 34 may be the same as or different from a structure of the second locking member 36. Exemplarily, the first locking member 34 may be disposed symmetrically with the second locking member 36.

Exemplarily, both the first locking member 34 and the second locking member 36 may be of a slider structure.

Referring to FIG. 6 and FIG. 12, in some exemplary embodiments, the second locking member 36 and the guide member 32 may cooperate to form a second positioning slot (not marked). One end of the elastic member 35 may be located in the first positioning slot 60, and the other end of the elastic member 35 may be located in the second positioning slot.

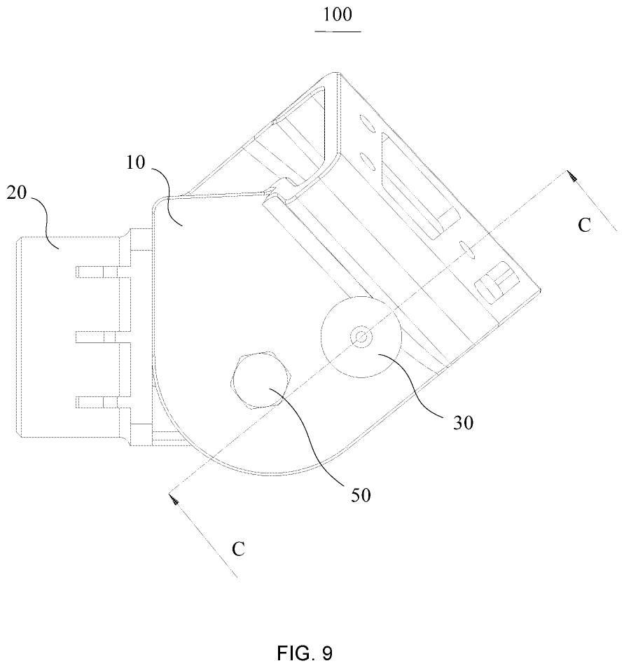

Referring to FIG. 9 and FIG. 10, in some exemplary embodiments, two ends of the elastic member 35 may abut against the first locking member 34 and the mounting member 10, respectively.

Exemplarily, the guide member 32 may be fixedly connected to the mounting member 10, and the operating member 31 can perform movement relative to the guide member 32. One end of the elastic member 35 may abut against the bottom wall of the first positioning slot 60, and the other end of the elastic member 35 may abut against the first mounting portion 12 of the mounting member 10.

Exemplarily, the guide member 32 is movable relative to the first mounting portion 12. Specifically, the guide member 32 is slidable relative to the second through hole 126 in the first mounting portion 12. When the operation end of the operating member 31 is pressed, the operating member 31 and the limiting member 33 may move relative to the guide member 32 along an axial direction of the guide hole 321, and when the operating member 31 and the limiting member 33 move relative to the guide member 32 to a specific position, the operating member 31 may drive the guide member 32 to move relative to the first mounting portion 12 along an axial direction of the second through hole 126, to enable the operating member 31 to drive the first locking member 34 to gradually leave the clamping slot 42 of the first limiting slot 43 through the slot opening 41 of the first limiting slot 43, and further enable the first locking member 34 to press the elastic member 35.

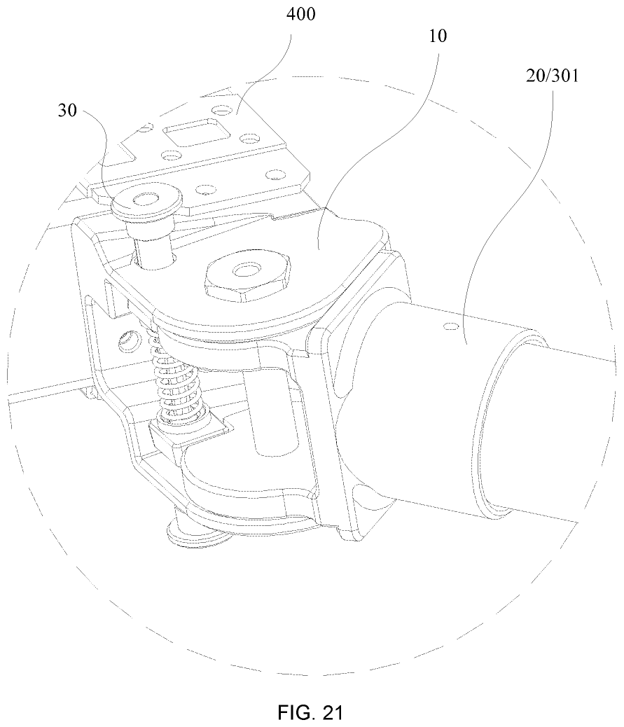

Referring to FIG. 19 to FIG. 21, some exemplary embodiments of the present disclosure further provide an arm assembly 300, which may include a locking structure 100 and a power kit 200. The locking structure 100 may be the locking structure 100 in any one of the foregoing exemplary embodiments. One of the mounting member 10 and the movable member 20 may be a connection member fixed to a center frame 400 of the movable platform 1000, and the other of the mounting member 10 and the movable member 20 may be an arm 301 configured to allow the power kit 200 to be disposed. The power kit 200 may be disposed on the arm 301.

According to the arm assembly 300 in some exemplary embodiments, during a process in which an arm 301 and a mounting member 10 rotate relative to each other to unfold the arm 301, when the arm 301 switches from a folded state to an unfolded state, a locking assembly 30 may automatically lock the mounting member 10 and the arm 301 synchronously, so that the arm 301 may be reliably kept in the unfolded state, and the mounting member 10 and the arm 301 may be locked, without an additional manual operation on the locking assembly 30, in a current position corresponding to the unfolded state. Therefore, the operation is simple and convenient, and a problem of potential safety hazards caused when an operator forgets to securely lock the arm 301 is avoided.

Referring to FIG. 19 to FIG. 21, some exemplary embodiments of the present disclosure further provide a movable platform 1000, which may include a locking structure 100 and a body, and the locking structure 100 may be disposed on the body. The locking structure 100 may be the locking structure 100 in any one of the foregoing exemplary embodiments.

The movable platform 1000 may be any object that is movable or automatically movable under an external force. For example, the movable platform 1000 may include a handheld gimbal or a UAV. Certainly, the movable platform 1000 may alternatively be an unmanned vehicle, an unmanned ship, a robot, or the like.

The following uses an example in which the movable platform 1000 is a UAV for explanation and description.

In some exemplary embodiments, the UAV may include a center frame 400, an arm 301, and a power kit 200 disposed on the arm 301. One end of the arm 301 may be connected to the center frame 400, and the power kit 200 may be mounted at the other end of the arm 301. There may be one, two, three or more arms 301. The arm 301 may be radialized and extend out of the body.

Exemplarily, the body of the movable platform 1000 may include a center frame 400.

In some exemplary embodiments, the UAV may further include a flight controller. The flight controller may be in communication with the power kit 200, so as to control operation of the power kit 200, thereby providing flight power for the UAV. Exemplarily, the flight controller may be configured to generate a control instruction, and send the control instruction to an electronic speed regulator of the power kit 200, so that the electronic speed regulator controls a drive motor of the power kit 200 according to the control instruction. The flight controller may be a device having a specific logical processing capability, for example, a control chip, a single-chip microcomputer, or a micro-controller unit.

In some exemplary embodiments, the power kit 200 may include an electronic speed regulator, a drive motor, and a propeller. The electronic speed regulator may be located in a cavity formed by the arm 301 or the body. The electronic speed regulator may be connected to each of the flight controller and the drive motor. Specifically, the electronic speed regulator may be electrically connected to the drive motor and configured to control the drive motor. The drive motor may be mounted on the arm 301, and a rotation shaft of the drive motor may be connected to the propeller. The propeller may be driven by the drive motor to generate force that enables the UAV to move, for example, a lift force or a thrust force that enables the UAV to move.

In some exemplary embodiments, at least one movement characteristic of the movable platform 1000 may be controlled by a user terminal. Exemplarily, the movable platform 1000 may be controlled by the user terminal to enable the movable platform 1000 to navigate toward a target object in an environment, or track a target object in an environment, and so on. The environment may include geographic features, plants, landmarks, buildings, people, vehicles, animals, emitters, and the like.

According to the movable platform 1000 in some exemplary embodiments, during a process in which a movable member 20 and a mounting member 10 rotate relative to each other to unfold the movable member 20, when the movable member 20 switches from a folded state to an unfolded state, a locking assembly 30 may automatically lock the mounting member 10 and the movable member 20 synchronously, so that the movable member 20 may be reliably kept in the unfolded state, and the mounting member 10 and the movable member 20 may be locked, without an additional manual operation on the locking assembly 30, in a current position corresponding to the unfolded state. Therefore, the operation is simple and convenient, and a problem of potential safety hazards caused when an operator forgets to securely lock the movable member 20 is avoided.

The foregoing descriptions are merely some exemplary embodiments of the present disclosure, but are not intended to limit the scope of protection of the present disclosure. Any equivalent modification or replacement readily figured out by a person skilled in the art within the technical scope disclosed in the present disclosure shall fall within the scope of protection of the present disclosure. Therefore, the scope of protection of the present disclosure shall be subject to the scope of protection of the claims.

What is claimed is:

1. A locking structure for a movable platform, comprising:
a mounting member;
a movable member, rotatably connected to the mounting member, so that the movable member being switchable between an unfolded state and a folded state; and
a locking assembly, disposed on the mounting member or the movable member, wherein
when the mounting member and the movable member rotate to form a preset angle, the locking assembly is capable of locking the mounting member and the movable member synchronously in a current position, so that the movable member is kept in the unfolded state.

2. The locking structure according to claim 1, wherein when the mounting member and the movable member rotate to form the preset angle,
the mounting member and the movable member cooperate to form at least one limiting slot including a slot opening and a clamping slot communicating with the slot opening; and
part of the locking assembly is accommodated in the at least one limiting slot to lock the mounting member and the movable member, and is capable of entering the clamping slot through the slot opening to enable the locking assembly to be clamped in the clamping slot.

3. The locking structure according to claim 2, wherein
the clamping slot includes a first slot wall and a second slot wall disposed oppositely;
the first slot wall is disposed on the mounting member;
the second slot wall is disposed on the movable member;
the first slot wall and the second slot wall are contactable with part of the locking assembly so as to lock the mounting member and the movable member;
a distance between the first slot wall and the second slot wall gradually decreases along an extension direction from one end, close to the slot opening, of each of the first slot wall and the second slot wall to one end, away from the slot opening, of each of the first slot wall and the second slot wall; and
at least one of the following occurs:
a distance between an end, close to the slot opening, of the first slot wall and an axis of the locking assembly is greater than a distance between an end, away from the slot opening, of the first slot wall and the axis of the locking assembly, or
a distance between an end, close to the slot opening, of the second slot wall and the axis of the locking assembly is greater than a distance between an end, away from the slot opening, of the second slot wall and the axis of the locking assembly, and
at least one of the following occurs:
a distance between the first slot wall and the axis of the locking assembly gradually decreases along an extension direction from the end, close to the slot opening, of the first slot wall to the end, away from the slot opening, of the first slot wall, or
a distance between the second slot wall and the axis of the locking assembly gradually decreases along an extension direction from the end, close to the slot opening, of the second slot wall to the end, away from the slot opening, of the second slot wall.

4. The locking structure according to claim 2, wherein the at least one limiting slots includes two limiting slots disposed at an interval along an axial direction of the locking assembly.

5. The locking structure according to claim 3, wherein
the mounting member includes a mounting body and two first mounting portions oppositely disposed at an interval on the mounting body;
the first mounting portions are fixedly connected to the mounting body and rotatably connected to the movable member;
the first mounting portions is capable of cooperating with the movable member to form the at least one limiting slot;
the movable member includes a connection body and at least one second mounting portion;
the at least one second mounting portion is fixedly connected to the connection body and rotatably connected to the first mounting portions; and
the first mounting portions are capable of cooperating with the at least one second mounting portion to form the at least one limiting slot.

6. The locking structure according to claim 5, wherein
the two first mounting portions are oppositely disposed at an interval to form an accommodation space to accommodate at least part of the at least one second mounting portion; and
the first mounting portions are rotatably connected to the at least one second mounting portion through at least one rotating shaft.

7. The locking structure according to claim 5, wherein the movable member further includes at least one stop portion disposed on the connection body;
the at least one stop portion is configured to cooperate with the first mounting portions to limit rotation between the first mounting portions and the at least one second mounting portions;
the at least one stop portion is disposed on at least one of the connection body, or the at least one second mounting portion in a protruding manner;
a protrusion portion is disposed on each first mounting portion;
the first slot wall is disposed on the protrusion portion;
the second slot wall is disposed on the at least one second mounting portion;
each first mounting portion is stepped;
the first slot wall is disposed on a stepped surface the first mounting portion; and
the second slot wall is disposed on the at least one second mounting portion.

8. The locking structure according to claim 2, wherein the locking assembly is disposed on the mounting member.

9. The locking structure according to claim 8, wherein
the at least one limiting slot includes a first limiting slot;
the locking assembly includes:
an operating member, disposed on the mounting member,
a guide member, disposed on the mounting member,
a limiting member, connected to the guide member and the operating member and configured to limit the guide member and the operating member,
a first locking member, sleeved over the operating member, wherein when the mounting member and the movable member rotate to form the preset angle, at least part of the first locking member is capable of synchronously entering the first limiting slot to lock the mounting member and the movable member synchronously in a current position, and
an elastic member, sleeved over the operating member and the guide member and abutting against the first locking member, wherein under an external force the operating member is configured to drive the first locking member to disengage from the first limiting slot; and
the operating member includes:
a pressing segment,
a first connection segment, penetrating through the first locking member, wherein one end of the first connection segment is connected to the pressing segment, and
a second connection segment, connected to anther end of the first connection segment, wherein the limiting member penetrates through the guide member and is connected to the second connection segment.

10. The locking structure according to claim 9, wherein
the pressing segment and the first connection segment form a first step;
the pressing segment is movable in a direction toward a slot opening of the first limiting slot under an external force to make the first step to abut against the first locking member and drive the first locking member to disengage from the first limiting slot;
a first penetration hole is formed on the first locking member and configured to be penetrated by the first connection segment; and
the first penetration hole cooperates with the first connection segment to form a first positioning slot to position the elastic member.

11. The locking structure according to claim 10, wherein
the first penetration hole includes a first sub-hole and a second sub-hole communicating with each other;
the second sub-hole is disposed away from the pressing segment, and cooperates with the first connection segment to form the first positioning slot;
a diameter of the second sub-hole is greater than a diameter of the first sub-hole;
a guide hole extending along an expansion direction of the elastic member is formed in the guide member; and
at least one of the operating member or the limiting member is configured to move along an axial direction of the guide hole.

12. The locking structure according to claim 11, wherein
the guide hole includes a first sub-guide hole and a second sub-guide hole communicating with each other;
a diameter of the first sub-guide hole is greater than a diameter of the second sub-guide hole, so as to form a second step; and
a large-diameter end of the limiting member is disposed in the first sub-guide hole.

13. The locking structure according to claim 9, wherein the limiting member includes a limiting screw.

14. The locking structure according to claim 9, wherein the first locking member includes:
a locking body;
a first locking surface; and
a second locking surface, oppositely disposed with the first locking surface on the locking body, wherein
the first locking surface and the second locking surface are configured to contact the mounting member and the movable member respectively, so as to lock the mounting member and the movable member.

15. The locking structure according to claim 9, wherein
the limiting slot includes a second limiting slot; and
the locking assembly further includes:
a second locking member, sleeved over the guide member, wherein
when the mounting member and the movable member rotate to form the preset angle, at least part of the second locking member is capable of synchronously entering the second limiting slot to lock the mounting member and the movable member synchronously in the current position,
two ends of the elastic member abut against the first locking member and the second locking member, respectively, and
the guide member is capable of driving the second locking member to disengage from the second limiting slot under an external force.

16. The locking structure according to claim 9, wherein two ends of the elastic member abut against the first locking member and the mounting member, respectively.

17. The locking structure according to claim 1, wherein
one of the mounting member and the movable member is a connection member configured to connect to a center frame of the movable platform; and
the other one of the mounting member and the movable member is an arm configured to allow a power kit to be disposed.

18. An arm assembly, comprising:
a locking structure, including:
a mounting member,
a movable member, rotatably connected to the mounting member, so that the movable member being switchable between an unfolded state and a folded state; and
a locking assembly, disposed on the mounting member or the movable member, and
a locking assembly, disposed on the mounting member or the movable member, wherein
when the mounting member and the movable member rotate to form a preset angle, the locking assembly is capable of locking the mounting member and the movable member synchronously in a current position, so that the movable member is kept in the unfolded state,
one of the mounting member and the movable member is a connection member fixed on a center frame of a movable platform, and
the other of the mounting member and the movable member is an arm configured to allow a power kit to be disposed; and
a power kit, disposed on the arm.

19. A movable platform, comprising:
a body; and
a locking structure disposed on the body, wherein
the locking structure including:
a mounting member,
a movable member, rotatably connected to the mounting member, so that the movable member being switchable between an unfolded state and a folded state, and
a locking assembly, disposed on the mounting member or the movable member, wherein
when the mounting member and the movable member rotate to form a preset angle, the locking assembly is capable of locking the mounting member and the movable member synchronously in a current position, so that the movable member is kept in the unfolded state.

20. The movable platform according to claim 19, further comprising:
a handheld gimbal; or
an unmanned aerial vehicle.
